(19) United States
(12) Patent Application Publication
(10) Pub. No.: US 2019/0379101 A1
(43) Pub. Date: Dec. 12, 2019

(54) RADOME MEMBRANE BLADDER AND SYSTEMS AND METHODS THEREOF

(71) Applicant: Lockheed Martin Corporation, Bethesda, MD (US)

(72) Inventor: Robert M. REESE, Mount Laurel, NJ (US)

(73) Assignee: Lockheed Martin Corporation, Bethesda, MD (US)

(21) Appl. No.: 16/002,621

(22) Filed: Jun. 7, 2018

(51) Int. Cl. H01Q 1/02; H01Q 1/42

(52) U.S. Cl. CPC H01Q 1/02; H01Q 1/427

(57) ABSTRACT

A radome membrane bladder and systems and methods thereof can comprise an inner membrane having an inner surface and an outer surface opposite the inner surface, an outer membrane having an inner surface facing the inner membrane and an outer surface facing away from the inner membrane, and at least one port configured to control the supply of air provided between the inner membrane and the outer membrane. At least the outer membrane is movable between a state where no air is provided between the inner membrane and the outer membrane and an outward state when air is being provided or has been provided between the inner membrane and the outer membrane. Movement of the outer membrane can prevent, minimize, and/or remove ice or snow or other foreign material buildup on the outer surface of the radome (i.e., the outer surface of the outer membrane).

### STATEMENT REGARDING FEDERALLY SPONSORED RESEARCH OR DEVELOPMENT

The invention was made with government support under contract HQ0147-16-C-0011 awarded by The Missile Defense Agency. The government has certain rights in the invention.

### FIELD

Embodiments of the disclosed subject matter involve radome membrane bladders and systems and methods thereof. In particular, embodiments of the disclosed subject matter can involve a radome membrane bladder, or a system or a method thereof, that can be controlled so as to move at least an outer surface of an outer membrane from an initial state to a stretched, increased tension, or expanded state and/or between the initial state and the stretched, increased tension, or expanded state.

### SUMMARY

According to one or more embodiments of the disclosed subject matter, an ice inhibiting radome system can be provided. The ice inhibiting system can be comprised of an air supply configured to provide an oscillating flow of air at a predetermined flow rate over a plurality of pressurization/depressurization oscillation cycles; a radome bladder fluidly connected to the air supply to receive the oscillating flow of air; a mechanical tensioning assembly coupled to the radome bladder and configured to provide adjustable tensioning of the inner stretched membrane and the outer stretched membrane; and control circuitry. The radome bladder can have an inner stretched membrane, an outer stretched membrane having an inner surface and a smooth outer surface, at least one air inlet port configured to receive the oscillating flow of air and provide the oscillating flow of air to a variable volume chamber defined between the inner stretched membrane and the outer stretched membrane, and at least one air outlet port configured to output air from the variable volume chamber defined between the inner stretched membrane and the outer stretched membrane. A peripheral portion of the inner stretched membrane can be fixed to a peripheral portion of the outer stretched membrane to create an air-tight seal. The control circuitry can be configured to control the air supply to controllably provide the oscillating flow of air at the predetermined flow rate to the variable volume chamber defined between the inner stretched membrane and the outer stretched membrane, via the at least one air input port, such that, for each said pressurization/depressurization oscillation cycle, the air causes adjacent portions of the inner stretched membrane and the outer stretched membrane to move apart and thereby increase the variable volume chamber during a pressurization phase of the oscillation cycle, and controllably output the air, via the at least one air output port, from the variable volume chamber, to cause the adjacent portions of the inner stretched membrane and the outer stretched membrane to move toward each other and thereby decrease the variable volume chamber during a depressurization phase of the oscillation cycle. During each of the pressurization/depressurization oscillation cycles each of the inner stretched membrane and the outer stretched membrane can go from a pre-stressed state to an increased-stress state and back to the pre-stressed state.

Additionally, one or more embodiments of the disclosed subject matter can provide or implement a method of removing or preventing ice and/or snow accumulation on a radome using a flexible radome bladder. The method can comprise providing the radome, where the radome can include: the flexible radome bladder, the flexible radome bladder being fluidly connected to an air supply to receive forced air from the air supply and having an inner membrane provided in parallel with and contacting an outer membrane, the outer membrane having an inner surface facing the inner membrane and an outer surface facing away from the inner membrane, at least one air inlet port configured to receive the forced air from the air supply and provide the forced air between the inner membrane and the outer membrane, and at least one air outlet port configured to output air from between the inner membrane and the outer membrane. The method can also comprise determining an ice and/or snow accumulation condition relative to the outer surface of the outer membrane; and controlling, using a processor, at least a center portion of the outer membrane to move away from a center portion of the inner membrane, responsive to said determining the ice and/or snow accumulation condition, by forcing the air from the air supply between the inner membrane and the outer membrane. The controlling can cause the outer membrane to move from a first pre-stressed state to a first increased-stress state.

According to one or more embodiments of the disclosed subject matter a flexible radome bladder system can be provided. The flexible radome bladder system can comprise: an inner tensioned membrane having an inner surface and an outer surface opposite the inner surface; an outer tensioned membrane provided adjacent to the inner tensioned membrane, where the outer tensioned membrane has an inner surface facing the inner tensioned membrane and an outer surface facing away from the inner tensioned membrane; at least one air inlet port configured to provide air between the outer tensioned membrane and the inner tensioned membrane; and at least one air outlet port configured to output the air provided between the outer tensioned membrane and the inner tensioned membrane. The inner tensioned membrane and the outer tensioned membrane can be affixed to each other to create an air-tight seal around the inner tensioned membrane and the outer tensioned membrane. The inner tensioned membrane and the outer tensioned membrane can be configured such that respective inner portions are movable between a pre-tensioned state where no air is being provided between the inner tensioned membrane and the outer tensioned membrane and a predetermined increased-tension state where air is being or has been provided between the inner tensioned membrane and the outer tensioned membrane.

Embodiments can also include methods of providing, making, and/or using apparatuses and systems, or portions thereof, according to one or more embodiments of the disclosed subject matter. Further, methods according to one or more embodiments of the disclosed subject matter may be computer-implemented methods in whole or in part, for instance, via a non-transitory computer-readable storage medium storing computer-readable instructions that, when executed by a computer, cause the computer to perform the method.

The preceding summary is to provide an understanding of some aspects of the disclosure. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The accompanying drawings, which are incorporated in and constitute a part of the specification, are illustrative of one or more embodiments of the disclosed subject matter, and, together with the description, explain various embodiments of the disclosed subject matter. Further, the accompanying drawings have not necessarily been drawn to scale, and any values or dimensions in the accompanying drawings are for illustration purposes only and may or may not represent actual or preferred values or dimensions. Where applicable, some or all select features may not be illustrated to assist in the description and understanding of underlying features.

FIG. 1 is a schematic illustration of a system according to one or more embodiments of the disclosed subject matter.

FIG. 2 is an overhead plan view of a radome bladder system according to one or more embodiments of the disclosed subject matter.

FIG. 3A is a cross-sectional view of the radome bladder system of FIG. 2 in a first state according to one or more embodiments of the disclosed subject matter.

FIG. 3B is a cross-sectional view of the radome bladder system of FIG. 2 in a second state according to one or more embodiments of the disclosed subject matter.

FIG. 4 is a cross-sectional partial view of a mounting system of a radome bladder system according to one or more embodiments of the disclosed subject matter.

FIG. 5 is an enlarged view of a perimeter portion of a radome bladder according to one or more embodiments of the disclosed subject matter, which is based on a portion of FIG. 4.

FIG. 6 is a block diagram of an electrical control system according to one or more embodiments of the disclosure.

FIG. 7 is a block diagram of a controller according to one or more embodiments of the disclosed subject matter.

FIG. 8 is a block diagram of a method, which may be a computer-implemented method in whole or in part, according to one or more embodiments of the disclosed subject matter.

FIG. 9 is a block diagram of a method, which may be a computer-implemented method in whole or in part, according to one or more embodiments of the disclosed subject matter.

### DETAILED DESCRIPTION

The description set forth below in connection with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, structures and components may be shown in block diagram form in order to avoid obscuring the concepts of the described subject matter. Wherever possible, the same reference numbers will be used throughout the drawings to refer to the same or the like parts.

Any reference in the specification to “one embodiment” or “an embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

It must also be noted that, as used in the specification, appended claims and abstract, the singular forms “a,” “an,” and “the” include plural referents unless the context clearly dictates otherwise. That is, unless clearly specified otherwise, as used herein the words “a” and “an” and the like carry the meaning of “one or more” or “at least one.” The phrases “at least one,” “one or more,” “or,” and “and/or” are open-ended expressions that can be both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” can mean A alone, B alone, C alone, A and B together, A and C together, B and C together, or A, B and C together. It is also to be noted that the terms “comprising,” “including,” and “having” can be used interchangeably.

It is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the described subject matter to any particular orientation or configuration. Furthermore, terms such as “first,” “second,” “third,” etc. merely identify one of a number of portions, components, points of reference, operations and/or functions as described herein, and likewise do not necessarily limit embodiments of the described subject matter to any particular configuration or orientation.

Control aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “circuitry,” “module” or “system.” Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, device, or portion thereof.

Generally, embodiments of the disclosed subject matter involve a radome membrane bladder and systems and methods thereof. More specifically, embodiments of the disclosed subject matter can involve a radome membrane bladder, or a system or a method thereof, that can be controlled, via introduction and release of forced air between two membranes, so as to move at least an outer membrane of the two membranes from an initial state to a stretched, increased tension, or expanded state and/or from the stretched, increased tension, or expanded state to the initial state. The outer membrane may form an outer surface of a radome, particularly a flat planar radome provided over at least one antenna aperture. As such, movement to the stretched, increased tension, or expanded state may prevent, minimize, and/or remove ice or snow or other foreign material buildup on the outer surface of the radome (i.e., the outer membrane of the radome membrane bladder). Such movement of the radome membrane bladder may not impact or adversely affect operation of the underlying radar. Incidentally, embodiments of the disclosed subject matter may be implemented in relatively small aperture radomes (e.g., for a 10-12′ antenna) and/or relatively large aperture radomes.

Such bladder, systems and methods can be comprised of an inner membrane having an inner surface and an outer surface opposite the inner surface, an outer membrane having an inner surface facing the inner membrane and an outer surface facing away from the inner membrane, and at least one port configured to control the air provided between the inner membrane and the outer membrane. For example, in one or more embodiments of the disclosed subject matter, a radome membrane bladder can be comprised of two back-to-back membranes (e.g., stretched or tensed) that can be joined together and sealed around a perimeter to create an air-tight seal.

The inner membrane and the outer membrane can be movable between a first state where no air is provided (and optionally retained) between the inner membrane and the outer membrane and a second state where air is being or has been provided (and retained) between the inner membrane and the outer membrane. The first state may be referred to as an initial or non-expanded state, though in one or more embodiments an inner volume may exist between the inner and outer membranes in the non-expanded state. Optionally, in the first state, the inner and outer membranes may be pre-stretched or pre-tensed. The second state may be referred to as an expanded state. Optionally, the second state may be referred to an increased tension state, whereby air introduced between the inner and outer membranes increases the tension of the membranes from a pre-tensed state. Of course, the expanded state may mean a maximum expanded state depending upon the amount of air introduced between the inner membrane and the outer membrane and the elastic characteristics of the inner and outer membranes. Additionally or alternatively, the expanded state may mean an intermediate expanded state between the initial state and the maximum expanded state.

As a non-limiting example, under icing conditions, or to de-ice the radome, air can be flowed between the membranes to expand the membrane bladder and then vented (i.e., discharged) from the bladder, for instance, in cyclic fashion, such as according to a predetermined pressurization/depressurization cycle. The expansion of the membrane bladder can curve and stretch at least the outer membrane, which can shatter any ice built up on the outer surface of the outer membrane. The cyclic operation may prevent further ice or snow adhesion to the outer surface of the outer membrane.

Optionally, the air provided between the inner and outer membranes may not be heated for the sole purpose of introducing heated air between the inner and outer membranes. For instance, the air may be the temperature of ambient air from within an enclosure formed by the radome membrane bladder. Consequently, the controlled introduction and release of non-heated air may not impact an infra-red (IR) signature of the radome. Alternatively, the air may be heated, for instance, by a heater, for the sole purpose of introducing heated air between the inner and outer membranes. Thus, in one or more embodiments of the disclosed subject matter, forced heated air behind the radome (i.e., to the outer surface of the inner radome membrane that faces the antenna) may not be employed.

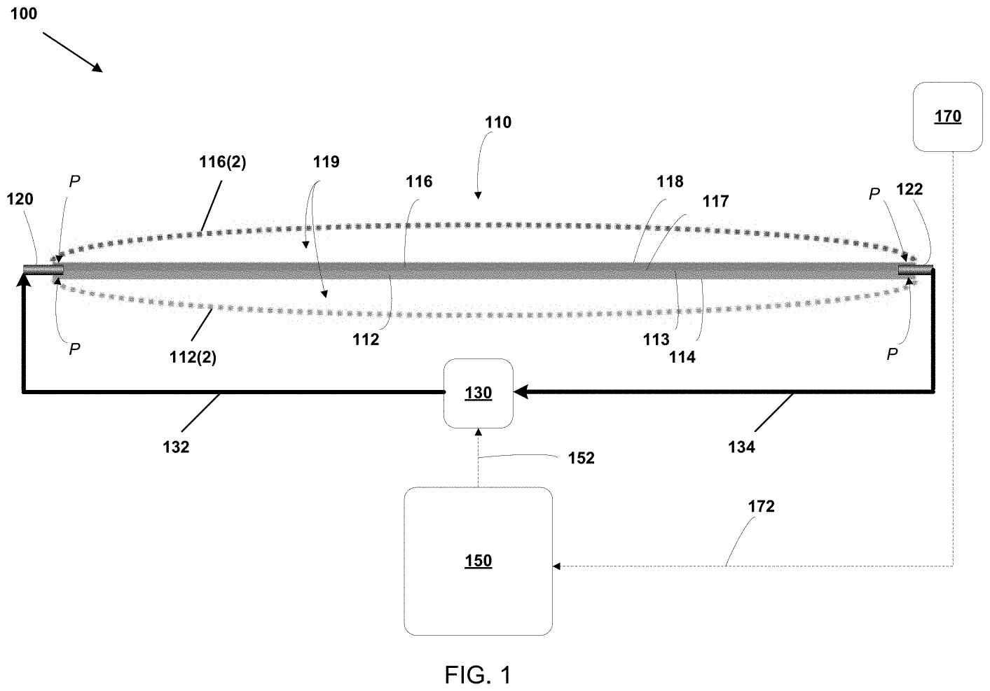

Turning now to the figures, FIG. 1 shows a block diagram of a system 100 according to one or more embodiments of the disclosed subject matter.

The system 100 can be comprised of a radome bladder 110, an air supply 130, and a controller 150. Optionally, the system 100 may have one or more sensors 170, which may sense conditions for activating the radome bladder 110 via air supplied from the air supply 130. Generally, sensor(s) 170 can detect impending or actual ice or snow or other foreign material buildup on the outer surface of the radome membrane bladder 110. For instance, the one or more sensors 170 may detect temperature, wind, and/or precipitation characteristics outside the radome, such as at the outer surface 118 of the outer membrane 116, to determine an impending, likely, or actual ice or snow or other foreign material build up condition. Additionally or alternatively, the one or more sensors 170 may sense an added weight to the outer surface 118 of the outer membrane 116, which may be indicative of actual buildup on the outer surface of the radome membrane bladder 110.

The radome bladder 110 can have an inner membrane 112 with an inner surface 113 and an outer surface 114, and an outer membrane 116 with an inner surface 117 and an outer surface 118. The inner surface 113 of the inner membrane 112 and the inner surface 117 of the outer membrane 116 may be affixed to each other at peripheral portions P to form an airtight seal. For instance, a 4-6′ airtight seal may be provided around the perimeter of the radome bladder 110. The inner surface 113 and the outer surface 114 may be heat bonded together to form the airtight seal, though embodiments of the disclosed subject matter are not so limited.

A chamber or inner volume 119 may be defined between the inner membrane 112 and the outer membrane 116. In one or more embodiments, the inner volume 119 may be zero or essentially zero when the inner surface 113 of the inner membrane 112 contacts the inner surface 117 of the outer membrane 116 in a first state, such as shown in FIG. 1. From the first state, the inner membrane 112 and the outer membrane 116 can be forced apart by the introduction of air therebetween to a second state, such as shown in FIG. 1 by the position of the inner membrane 112(2) and the outer membrane 116(2), where the inner volume 119 (of the chamber) is greater than in the first state. Of course, in one or more embodiments a center portion of the inner surface 113 of the inner membrane 112 may not contact a corresponding center portion of the inner surface 117 of the outer membrane 116 in the first state, meaning that the chamber or inner volume 119 in the first state can be greater than zero or greater than essentially zero.

At least the outer surface 118 of outer membrane 116 can have a relatively smooth surface and/or coating that may minimize adherence thereto of ice or snow or other foreign material. For example, the outer surface 118 of the outer membrane 116 may have a coating of polytetrafluoroethylene (PTFE).

The radome bladder 110 may also have at least one air duct or port. FIG. 1, for instance, shows an air inlet port 120 and an air outlet port 122. Generally, the air inlet port 120 can introduce air between the inner membrane 112 and the outer membrane 116, and the air outlet port 122 can allow air between the inner membrane 112 and the outer membrane 116 to escape from the radome bladder 110. Further, in one or more embodiments, the radome bladder 110 can have a plurality of air inlet ports 120 and/or a plurality of air outlet ports 122. Alternatively, one or more air inlet ports 120 can be provided, where such one or more air inlet ports 120 can introduce air between the inner membrane 112 and the outer membrane 116 and allow air between the inner membrane 112 and the outer membrane 116 to escape from the radome bladder 110. That is, in one or more embodiments, the air inlet port(s) 120 can operate as an air inlet port and an air outlet port.

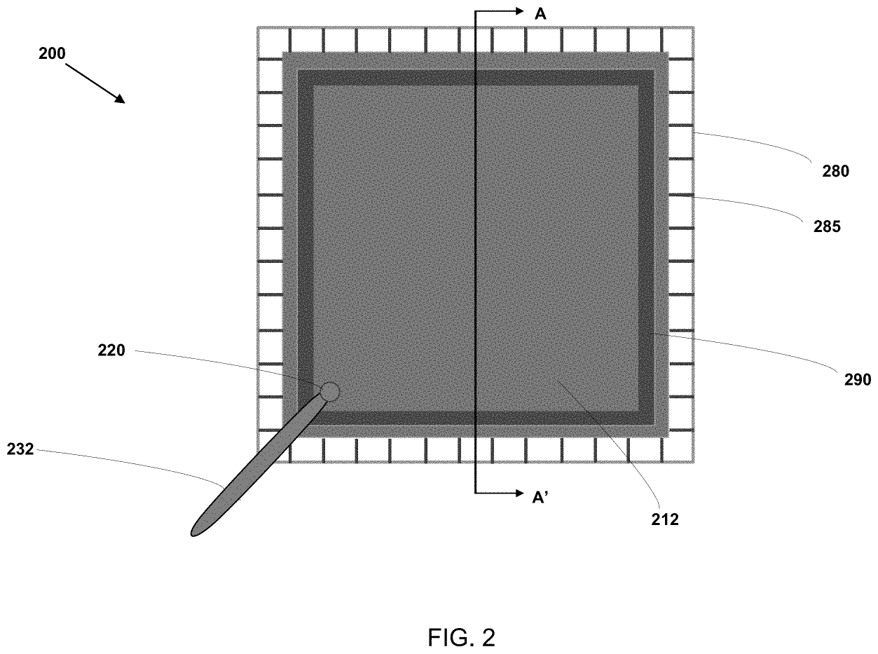

The air inlet port 120 and/or the air outlet port 122 can be at or adjacent to an edge, a perimeter, or a periphery of the radome bladder 110 where the inner membrane 112 and the outer membrane 116 are fixed together. For example, the air inlet port 120 and/or the air outlet port 122 may be provided at respective peripheral edge portions of the radome bladder 110, such as diagrammatically illustrated in FIG. 1. Thus, an air-tight seal may be provided at the periphery of the radome bladder 110, except for where the air inlet port 120 and/or the air outlet port 122 are provided. Alternatively, the air inlet port 120 and/or the air outlet port 122 may be provided individually through the air inlet port 120 or the air outlet port 122, such as illustrated in FIG. 2. In one or more embodiments of the disclosed subject matter, each of the at least one air duct or port may be positioned such that the radar antenna does not irradiate the at least one air duct or port.

The air supply 130 can supply air at a predetermined flow rate (or rates) to between the inner membrane 112 and the outer membrane 116 via the at least one air inlet port 120. The air supply 130 may be a blower, such as an industrial blower or an air compressor. Further, air supply 130 may be comprised of an air supply line 132 between the air supply 130 and the air inlet port 120, and configured to pass air from the air supply 130 to the air inlet port 120.

Optionally, in one or more embodiments, the air provided between the inner membrane 112 and the outer membrane 116 may be heated. For example, air supply 130 may include a heater configured to heat the air for supply of heated air between the inner membrane 112 and the outer membrane 116. Alternatively, the system 100 can include a heater (not expressly shown in FIG. 1) that is separate from the air supply 130, where the heater is configured to heat air prior to processing and output from the air supply 130 and/or to heat air after the air is output from the air supply 130, but prior to the heated air being provided between the inner membrane 112 and the outer membrane 116. A heater according to one or more embodiments of the disclosed subject matter can include an electrical resistor, a burner, and/or a heat exchanger (e.g., a gas-gas heat exchanger, and/or a liquid-gas heat exchanger). As a non-limiting example, air provided between the inner membrane 112 and the outer membrane 116 may be heated to a temperature above freezing.

Optionally, an air discharge line 134 may be provided at the at least one air outlet port 122. FIG. 1 shows the air discharge line 134 being coupled to the air supply 130 to recycle air discharged from the air outlet port 122 back to the air supply 130. However, optionally, the air discharge line 134 may not supply air back to the air supply 130 and, instead, may merely discharge the air from the air outlet port 122 elsewhere, such as the interior of the radome or outside the radome. Not expressly shown in FIG. 1, the air supply 130 may implement one or more flow control mechanisms, such as a valve, to control flow of air to the air inlet port 120. Likewise, one or more flow control mechanisms, such as a valve, may be implemented to control flow of air from the air outlet port 122. Such flow control mechanisms may be implemented in the air supply 130, the air supply line 132, and/or the air discharge line 134.

The controller 150 can be coupled, for instance, electrically, to the air supply 130 via a control interface 152. In the case of the optional at least one sensor 170, the at least one sensor 170 may be electrically coupled to the controller 150 via a feedback interface 172, which may be a wired and/or wireless communication interface.

The controller 150 may include a processor, memory, and a network interface (not expressly shown). The controller 150 may also include circuitry components such as a bus to provide communication and control data between components of the controller 150. The controller 150 may further include an input/output interface that may facilitate communication with various components, such as the sensor(s) 170, the air supply 130, and/or actuator(s) associated with the control mechanism(s) to control the flow of the air into and/or out of the radome bladder 110. In one or more embodiments, the controller 150 may be a single controller. The controller 150 may control operation of the air supply 130 and, thus, the radome bladder 110, by executing operating instructions, such as, computer readable program code stored in the memory. The operations may be initiated based on an external input, such as based on signals from the sensor(s) 170 and/or user input via a control panel (not expressly shown). Various other components may be associated with the controller 150 including, but not limited to, a power supply module or modules, a signal processing module or modules, etc.

The controller 150 may send control signals to control the supply of air from the air supply 130 to between the inner membrane 112 and the outer membrane 116 via the air inlet port 120. Likewise, the controller 150 may send control signals to control the discharge of air from between the inner membrane 112 and the outer membrane 116 via the air outlet port 122. For example, the controller 150 may control air to and from the radome bladder 110 according to a predetermined cycle. The air supply/discharge cycle, which may be referred to as a pressurization/depressurization cycle, may be set in terms of seconds or minutes, for instance, for any time from about three seconds to about three minutes. Further, the air flow rate may be relatively low given the relatively small maximum amount for the inner volume 119. For instance, the flow rate for air into and/or out of the radome bladder 110 may be between about 1 m³/s to about 20 m³/s.

Optionally, the air supply/discharge cycle may be according to a symmetrical pattern, meaning that the air supply portion can be the same amount of time as the discharge cycle and/or at the same flow rate. Alternatively, according to one or more embodiments, the air supply/discharge cycle may be asymmetrical, meaning that the air supply portion can be for a different amount of time from the discharge cycle and/or at different flow rates. For example, the flow rate of air for the air supply portion of the cycle may be greater than the flow rate of air output from the radome bladder 110 for the discharge cycle. Further, in one or more embodiments, the flow rate of air may vary during the air supply portion and/or the air discharge portion of the cycle. For instance, the flow rate of air may be greater at the start of the air supply portion of the cycle, for instance, to more rapidly expand the chamber or inner volume 119, and may decrease until an end of the air supply portion of the cycle is reached. In this example, the air flow rate of air exiting the radome bladder 110 may be constant for the entire portion of the discharge portion of the cycle, though the discharge flow rate may be less than for some or all of the flow rate for the air supply portion of the cycle. Optionally, air may not be provided between the inner membrane 112 and the outer membrane 116 during some or all of the air discharge portion of the cycle. That is, air may be provided between the inner membrane 112 and the outer membrane 116 only during the air supply or pressurization phase of the cycle. Optionally, the air provided between the inner membrane 112 and the outer membrane 116 may be held therebetween, i.e., no air is output from the air outlet port 122. Thus, the chamber that defines the inner volume 119 may be pressurized.

Additionally, according to one or more embodiments of the disclosed subject matter, the air supply/discharge cycle may repeat or oscillate, for instance, for a predetermined time period, or for a predetermined number of cycles. Optionally, the predetermined time period or predetermined number of cycles may be set based on data from the sensor(s) 170. Alternatively, the air supply/discharge cycle may not repeat, either stopping after a single cycle, or according to difference cycle characteristics, such as for a different amount of time or air flow rate(s). For instance, for a subsequent air supply/discharge cycle the air flow rate for the air supply portion of the cycle may be less than that of the previous air supply/discharge cycle.

The inner membrane 112 and/or the outer membrane 116 may have an initial state whereby the membrane(s) is/are stretched or pre-tensed. For example, referring to FIG. 1, the solid lines can represent the inner membrane 112 and the outer membrane 116 in the initial, stretched or pre-tensed state. The dashed lines in FIG. 1 can represent the inner membrane 112(2) and the outer membrane 116(2) according to an increased stretched/tensed state, which may occur when air is provided between the inner membrane 112 and the outer membrane 116.

Discussed in more detail below, in one or more embodiments of the disclosed subject matter, the system 100, for instance, the radome bladder 130, may have a mechanical tensioning assembly. Generally, the mechanical tensioning assembly, according to embodiments of the disclosed subject matter, may pull the inner membrane 112 and/or the outer membrane 116 so the membrane(s) is/are relatively tight. Of course, the mechanical tensioning assembly may not keep the inner membrane 112 and/or the outer membrane 116 so tight that they cannot be further stretched or expanded upon the instruction of air between the inner membrane 112 and the outer membrane 116. Optionally, the mechanical tensioning assembly may be adjustable to modify the initial stretched or pre-tensed state of the inner membrane 112 and/or the outer membrane 116.

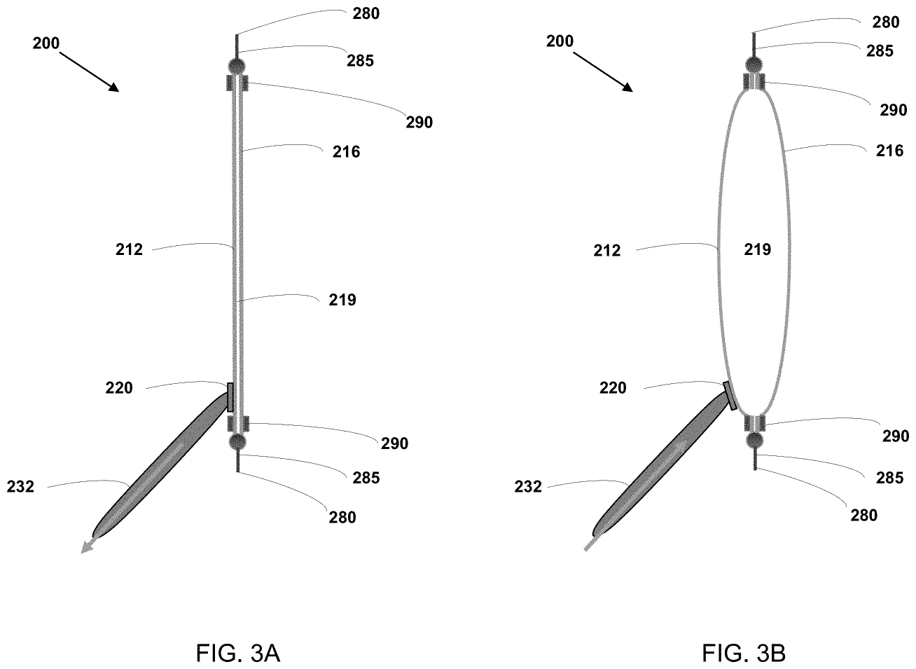

FIG. 2 is an overhead plan view of a radome bladder system 200 according to one or more embodiments of the disclosed subject matter. FIGS. 3A and 3B are cross-sectional views from line A-A′ of FIG. 2 of the radome bladder system 200.

A radome bladder of the radome bladder system 200 optionally can be square in the plan view, such as shown in FIG. 2. Of course, the radome bladder can take alternative shapes in the plan view, such as a rectangle or some other polygon. The radome bladder can have an inner membrane 212, an outer membrane 216, and an air inlet port 220. The air inlet port 220 can be coupled to an air supply line 232, which can supply air provided by an air supply (not shown).

Optionally, a mounting system may be provided, as part of the radome bladder system 200 or as a separate system, to hold the inner membrane 212 and the outer membrane 216. Mounting systems according to embodiments of the disclosed subject matter can be comprised of a mounting frame 280, a tensioning assembly 285, and a clamp apparatus 290. In one or more embodiments, the inner membrane 212 and the outer membrane 216 can be held in a pre-stretched or pre-tensed state.

Generally, the mounting frame 280 may provide a frame on which to mount the inner membrane 212 and the outer membrane 216. For example, tensioning assembly 285 may be coupled to the mounting frame 280 and edge portions of the inner membrane 212 and the outer membrane 216. Optionally, the tensioning assembly 285 may be adjustable to increase or decrease tension of the inner membrane 212 and the outer membrane 216. The clamp apparatus 290 may sandwich a portion of the inner membrane 212 and the outer membrane 216 and define an outer boundary of the inner volume 219. That is, the clamp apparatus 290 may define a boundary at which the inner membrane 212 and the outer membrane 216 are allowed to expand and contract due to air introduced therebetween.

Turning to FIG. 3A, this figure shows the radome bladder in a first state, which, as noted above, may be referred to herein as a non-expanded or depressurized state. In the first state, the inner membrane 212 and the outer membrane 216 may not be pushed apart from each other because either air from an air supply is not provided therebetween via the air inlet port 220 and the air supply line 232 or because air from an air supply is not held between the inner membrane 212 and the outer membrane 216. Optionally, in the first state, the inner membrane 212 and the outer membrane 216 may be parallel to each other, such as shown in FIG. 3A. Further, in the first state, no space or substantially no space may be provided between the inner membrane 212 and the outer membrane 216. Alternatively, a relatively small amount of space may be provided as the inner volume 219.

FIG. 3B shows the radome bladder in a second state, which may be referred to herein as an expanded or pressurized state. In the second state, air from the air supply may be provided between the inner membrane 212 and the outer membrane 216 such that the inner membrane 212 and the outer membrane 216 are moved apart from each other. Notably, the inner volume 219 is greater in the second state (FIG. 3B) than in the first state (FIG. 3A).

As shown in FIGS. 2, 3A, and 3B, the air inlet port 220 may also serve as an air outlet port. That is, air may be introduced between the inner membrane 212 and the outer membrane 216 via the air inlet port 220 to cause the inner volume 219 to expand, and air may be discharged from the port 220 to cause the inner volume 219 to contract and the inner membrane 212 and the outer membrane 216 to move toward each other, for instance, to reach the first state. Thus, in one or more embodiments, the air supply can push air and pull air to and from between the inner membrane 212 and the outer membrane 216. Control of air provided between the inner membrane 212 and the outer membrane 216, i.e., the introduction and/or discharge of air, can be by way of inputs to a controller, such as controller 150 in FIG. 1. The inputs can come from a user interface and/or one or more sensors, such as sensor 170 in FIG. 1.

Due to the relative small scale of the flexible inner volume 219 provided by the radome bladder, the volume of air that may need to be provided and optionally heated can be reduced relative to the amount of air and heating capacity to heat a volume of air behind the inner membrane 212. Thus, in one or more embodiments, it may not be necessary to heat the enclosed air behind the inner membrane 212 in an effort to prevent or minimize ice, snow, or other foreign material accumulation on the outer surface of the radome bladder (i.e., the outer surface of outer membrane 216).

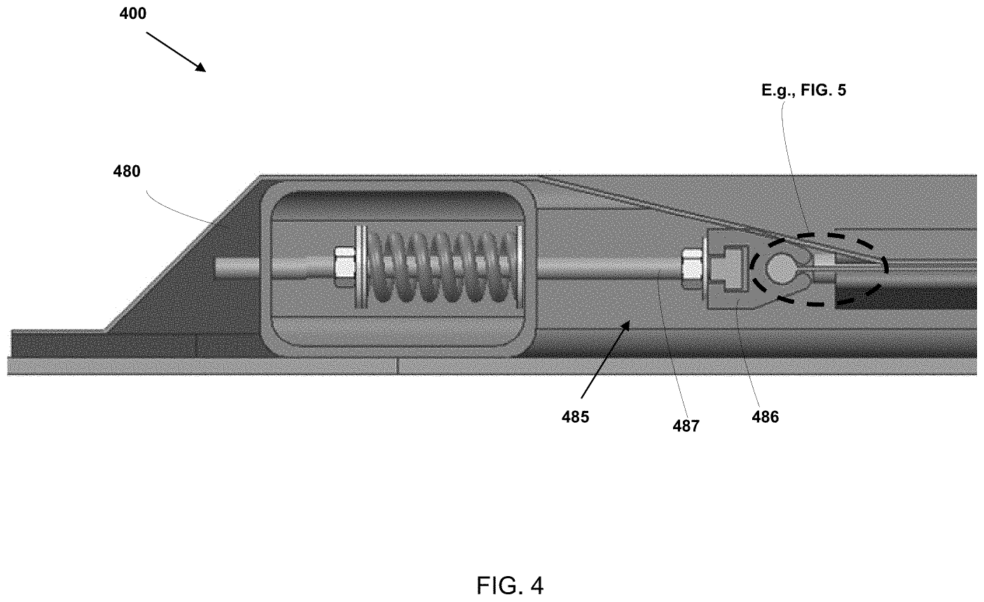

FIG. 4 is cross-sectional partial view of a mounting system 400 according to one or more embodiments of the disclosed subject matter. Of course, mounting system 400 is merely a non-limiting example.

The mounting system 400 can include a mounting frame 480 and a tensioning assembly 485. A radome bladder can be held by the mounting frame 480 via the tensioning assembly 485. For example, the tensing assembly 485 may include an edge rail 486 and a tensioning rod 487. The edge rail 486, at one side, can be coupled to an edge portion of the radome bladder, and at an opposite side coupled to the tensioning rod 487. The tensioning rod 487 can be coupled to the mounting frame 480, such as shown in FIG. 4.

Tension from the tensioning rod 487 may be based on a biasing member, such as a spring. And as noted above, the tension from the tensing rod 487 applied to the radome bladder can be adjusted, for instance, by adjusting a nut on the tensing rod 487 to adjust the bias provided by the biasing member. Though FIG. 4 shows only one edge rail 486 and only one tensioning rod 487, as schematically shown in FIG. 2, for instance, embodiments of the disclosed subject matter can have more than one tensioning rod 487 and/or more than one edge rail 486, such that the radome bladder is supported from all sides about its periphery.

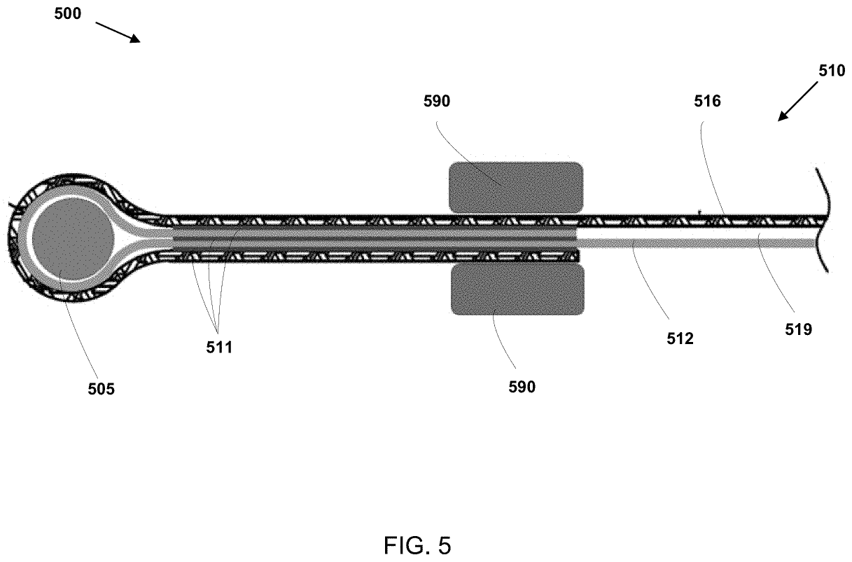

FIG. 5 is an enlarged view of a perimeter portion of a radome bladder 510 of a radome bladder system 500 according to one or more embodiments of the disclosed subject matter. The enlarged view of FIG. 5 is based on the portion of FIG. 4 identified by the broken-line oval pattern.

FIG. 5 shows that the radome bladder 510 can include inner membrane 512 and outer membrane 516. As shown, a clamp apparatus 590 can sandwich a portion of the inner membrane 512 and the outer membrane 516 and may define an outer boundary of an inner volume 519 of the radome bladder 500. Put another way, the clamp apparatus 590 may define a boundary at which the inner membrane 512 and the outer membrane 516 are allowed to expand and contract due to air provided therebetween. FIG. 5 shows clamp apparatus 590 in the form of top and bottom clamp bars. However, alternative embodiments may implement clamping via an edge rail or perimeter stitching.

Generally, edge portions of the inner membrane 512 and the outer membrane 516 may be fixed to each other, for instance, laminated, to create an air-tight seal around a perimeter of the radome bladder 500. For instance, adhesive bonds 511 may be provided. More specifically, an adhesive bond 511 may bond portions of the inner membrane 512 to each other, and adhesive bonds 511 may bond portions of the outer membrane 516 respectively to the portions of the inner membrane 512, such as shown in FIG. 5. Of course, adhesive bonds 511 are merely examples, and the portions of the inner membrane 512 and the outer membrane 516 may be fixed to each in a manner different from adhesive bonds 511, such as stitching, etc.

Further, a strip 505, such as a strip made from high-density polyethylene (HDPE), may be provided as part of the radome bladder system 500, or specifically the radome bladder 510, for coupling to a tensioning assembly (not expressly shown), such as tensioning assembly 285 of FIG. 2 or tensing assembly 485 of FIG. 4, or a variation thereof. FIG. 5, for instance, shows the inner membrane 512 and the outer membrane 516 being successively wrapped around the strip 505 and then adhesively bonded via adhesive bonds 511.

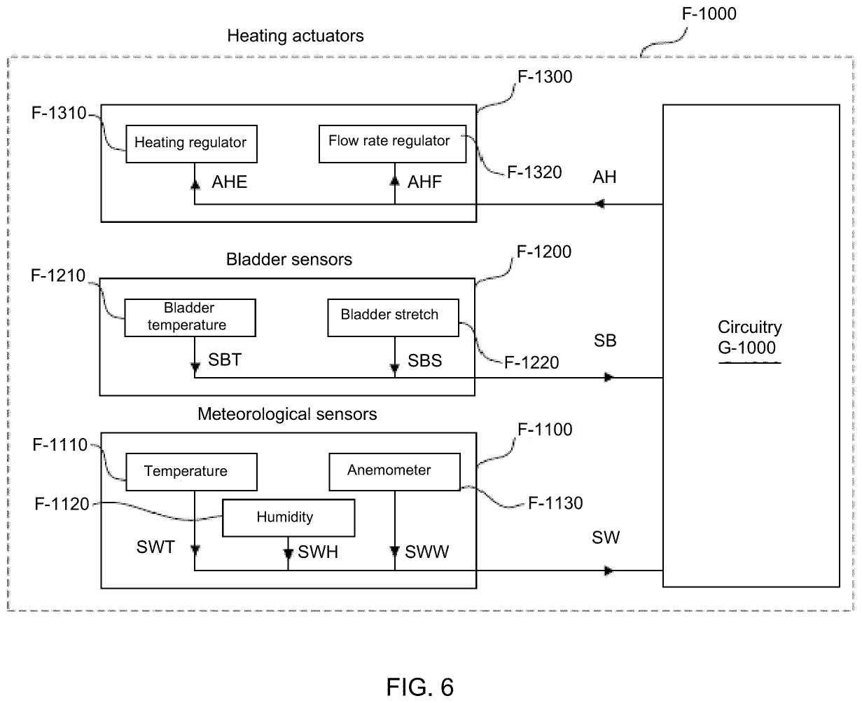

FIG. 6 is a block diagram of an electronic control system or unit F-1000 of or for radome systems according to one or more embodiments of the disclosure. Optionally, the electronic control unit F-1000 may be representative of the controller 150 of FIG. 1, or a portion thereof.

Generally, the electronic control unit F-1000 can control the supply of air, for instance, heated air, between the inner membrane and the outer membrane as described herein. Optionally, the electronic control unit F-1000 can control air provided between the inner membrane and the outer membrane in response to an input from a user at a user interface (not expressly shown), for instance. Additionally or alternatively, electrical control unit F-1000 can acquire data corresponding to sensed or detected conditions pertaining to the control of air between the inner membrane and the outer membrane, and control air provided between the inner membrane and the outer membrane based on such acquired data. Examples of conditions pertaining to the control of air between the inner membrane and the outer membrane include meteorological conditions regarding an environment external to the radome system, such as temperature, wind strength, wind directions, and/or humidity, and radome bladder conditions, such as surface temperature, weight, stretch level, strain level.

The electrical control unit F-1000 can include circuitry G-1000, which may be operatively coupled to one or more sensors configured to sense or detect conditions pertaining to the control of air between the inner membrane and the outer membrane. Some or all of the sensors shown in FIG. 6 may be represented by sensor 170 in FIG. 1. For example, FIG. 6 shows as non-limiting examples meteorological sensors F-1100 and bladder sensors F-1200, each of which may be arranged relative to the radome bladder.

The meteorological sensors F-1100 can include one or more of a temperature sensor F-1110 to provide temperature signals SWT indicative of temperature outside the radome system, a humidity sensor F-1120 to provide humidity signals SWH indicative of an external level of humidity, and an anemometer sensor F 1130 to provide wind signals SWW indicative of wind strength and wind direction outside the radome system.

The bladder sensor F-1200 can provide a plurality of bladder sensing signals SB indicative of bladder conditions, for instance, temperature, weight, stretch levels and/or any other physical properties that may be relevant to monitor the functioning of the bladder system. For example, the bladder sensor F-1200 can include at least one bladder temperature sensor F-1210 to provide bladder temperature signals SBT indicative of temperatures at an outer surface (i.e., the outer surface of the outer membrane) of the radome bladder. Additionally or alternatively, the temperature sensor F-1210 can provide signals indicative of a temperature between the inner and outer membranes. Optionally, in addition to controlling air between the inner and outer membranes, such temperature signals can be used to control whether or not the air is heated and provided between the inner and outer membranes. As another example, the bladder sensor F-1200 can include at least one bladder stretch sensor F-1220, e.g., a strain gauge assembly, to provide bladder stretch signals SBS indicative of stretch levels and/or strain levels of the inner membrane and/or the outer membrane of the radome bladder. The bladder stretch signals may additionally or alternatively be indicative of a weight from an external source applied to the outer surface of the outer membrane. Detecting such weight applied to the outer surface of the outer membrane may be indicative of ice or snow or other foreign material buildup on the outer surface of the outer membrane of the radome bladder.

The electrical control unit F-1000 can also include at least one heating system actuator F-1300. The heating system F-1300 can be operatively connected to the circuitry G-1000. The optional heating system can be comprised of actuators F-1300 that can receive heating actuation signals AH indicative of heating needs for the radome bladder system. For example, the heating system actuators F-1300 can include a heating regulator F-1310 that receives heating energy signals AHE indicative of an identified need to increase temperature of air to be provided between the inner and outer membranes. Such heating energy signals can be based on data from one or more other sensors, such as one or more of the meteorological sensors F-1100 and/or one or more of the bladder sensors F-1200. That is, the heating regulator F-1310 can control whether air to be provided between the inner and outer membranes is heated by a heating system and, if so, a temperature to which to heat the air. As another example, the heating system actuators F-1300 can include a heating flow regulator F-1320 that can receive flow actuation signals AHF indicative of a flow rate at which to control the rate of heated air to be provided between the inner and outer membranes.

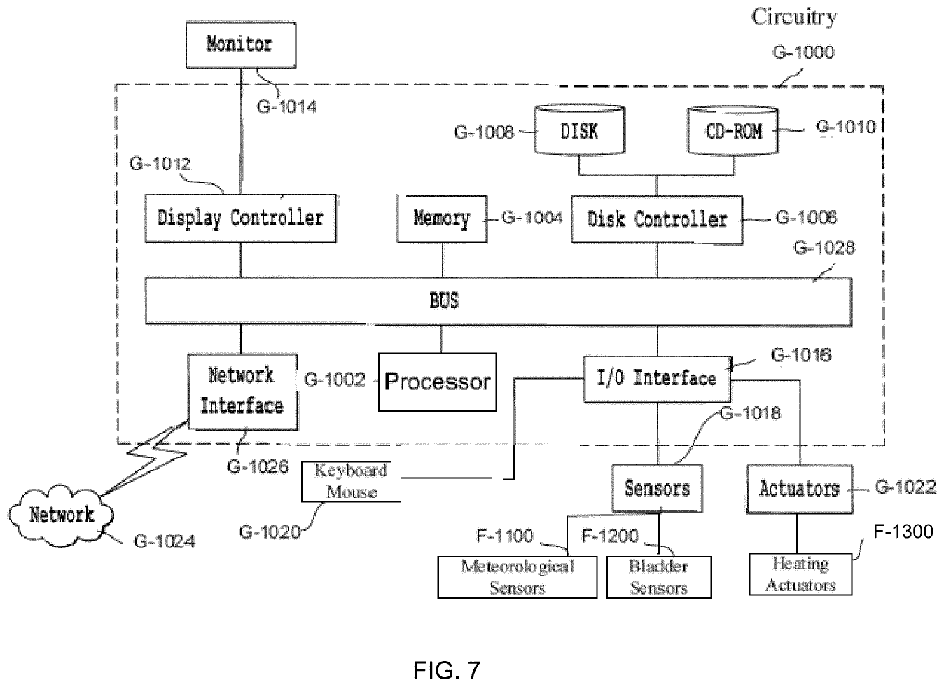

FIG. 7 is a block diagram of a controller according to one or more embodiments of the disclosed subject matter. As shown in FIG. 7, the controller may be implemented in circuitry, although embodiments of the disclosed subject matter are not limited to entirely hardware implementations for control.

Systems, apparatuses, operations, and processes in accordance with embodiments of the disclosed subject matter may be implemented using a processor G-1002 or at least one application specific processor (ASP). The processor G-1002 may utilize a computer readable storage medium, such as a memory G-1004 (e.g., ROM, EPROM, EEPROM, flash memory, static memory, DRAM, SDRAM, and their equivalents), configured to control the processor G-1002 to perform and/or control the systems, operations, and processes of this disclosure. Other storage mediums may be controlled via a disk controller G-1006, which may control a hard disk drive G-1008 or optical disk drive G-1010.

The processor G-1002 or aspects thereof, in an alternate embodiment, can include or exclusively include a logic device for augmenting or fully implementing this disclosure. Such a logic device includes, but is not limited to, an application-specific integrated circuit (ASIC), a field programmable gate array (FPGA), a generic-array of logic (GAL), and their equivalents. The processor G-1002 may be a separate device or a single processing mechanism. Further, this disclosure may implement parallel processing capabilities of a multi-core processor. A bus G-1028 may be provided for data transfer between the various components of the circuitry G-1000.

In another aspect, results of processing in accordance with this disclosure may be displayed using a display controller G-1012 to a monitor G-1014 that may be peripheral to or part of the circuitry G-1000. Moreover, the monitor G-1014 may be provided with a touch-sensitive interface to a command/instruction interface. The display controller G-1012 may also include at least one graphic processing unit for improved computational efficiency. Optionally, the monitor G-1014 may be part of a mobile electronic device, such as a mobile cellular phone or a tablet.

Additionally, the circuitry G-1000 may include an I/O (input/output) interface G-1016, provided for inputting sensor data from sensors G-1018 and for outputting orders to actuators G-1022. The sensors G-1018 and actuators G-1022 are illustrative of any of the sensors and actuators described in this disclosure. For example, the sensors G-1018 can be one or more of the bladder sensors F-1200 and/or the meteorological sensors F-1100 of FIG. 6, while the actuators G-1022 can be the one or more of the heating actuators F-1300 of FIG. 6.

Further, other input devices may be connected to an I/O interface G-1016 as peripherals or as part of the circuitry G-1000. For example, a keyboard or a pointing device such as a mouse G-1020 may control parameters of the various processes and algorithms of this disclosure, and may be connected to the I/O interface G-1016 to provide additional functionality and configuration options, or to control display characteristics. Actuators G-1022 which may be embodied in any of the elements of the apparatuses described in this disclosure may also be connected to the I/O interface G-1016. Thus, optionally, a user may manually activate (or deactivate), air supplied to between the inner membrane and the outer membrane and/or whether such air is heated or not, in an embodiment where at least one heater is implemented to heat for supply of heater air to between the inner membrane and the outer membrane. Optionally, a network interface G-1026, which may be wired and/or wireless, may be provided to output data to an external device (not shown) via a network G-1024.

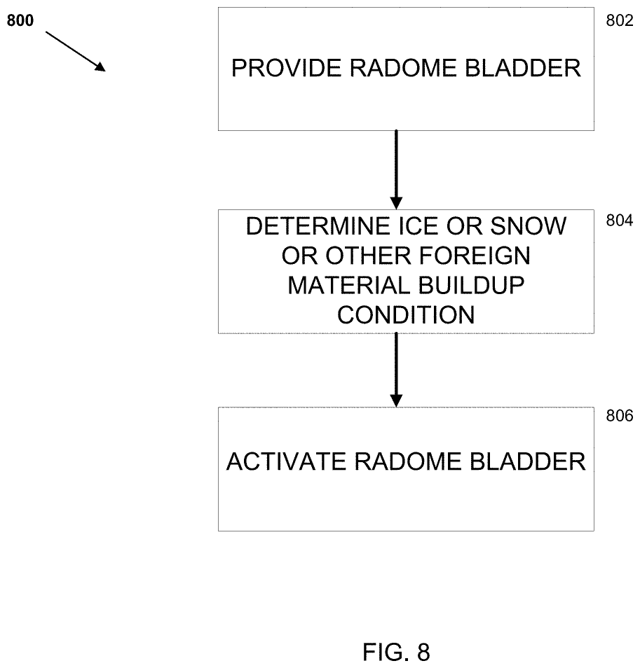

FIG. 8 is a block diagram of a method 800 according to one or more embodiments of the disclosed subject matter. The method 800, generally speaking, may be implemented to prevent, minimize, or remove unwanted accumulation of a foreign material, such as ice or snow, on an outer surface of a radome, such as the radome 1000.

The method 800 can include, at block 802, providing a flexible radome bladder, such as radome bladder 110 or radome bladder 510, or as otherwise described herein. For example, the flexible radome bladder may include providing the flexible radome bladder, as part of a radome, for instance. The flexible radome bladder can be configured to be fluidly connected to an air supply to receive forced air from the air supply and can have an inner membrane provided adjacent to an outer membrane. The outer membrane can have an inner surface that is adjacent to an inner surface of the inner membrane, and an outer surface that can face away from the inner membrane, at least one air inlet port configured to receive the forced air from the air supply and provide the forced air between the inner membrane and the outer membrane, and at least one air outlet port configured to output air from between the inner membrane and the outer membrane.

The method 800, at block 804, can determine an accumulation condition for unwanted foreign material buildup on the outer surface of the outer membrane. Such determining can be performed using at least one sensor 170/F-1100/F-1200, which can send signal(s) to controller 150/electronic control unit F-1000 that are indicative of an actual or likely accumulation condition for ice, snow, or other foreign material buildup on the outer surface of the outer membrane.

At block 806, the method can activate the radome bladder in response to signal(s) at block 804 that indicate an actual or likely accumulation condition. Such activation can be performed using the controller 150/electronic control unit F-1000 to send a control signal or signals to at least the air supply, such as air supply 130, to controllably provide air to the radome bladder.

As discussed above, providing air to the radome bladder can cause at least the outer membrane of the radome bladder to move from a first state to a second state. The first state may be an unexpanded state and the second state may be an expanded state. Optionally, the unexpanded state may be a pre-stressed, pre-stretched, or pre-tensed state, and the expanded state may be an increased stressed, stretched or tensed state. Activation may also include expelling air from the radome bladder to return the radome bladder to the first state. As discussed above, this cycle may be repeated.

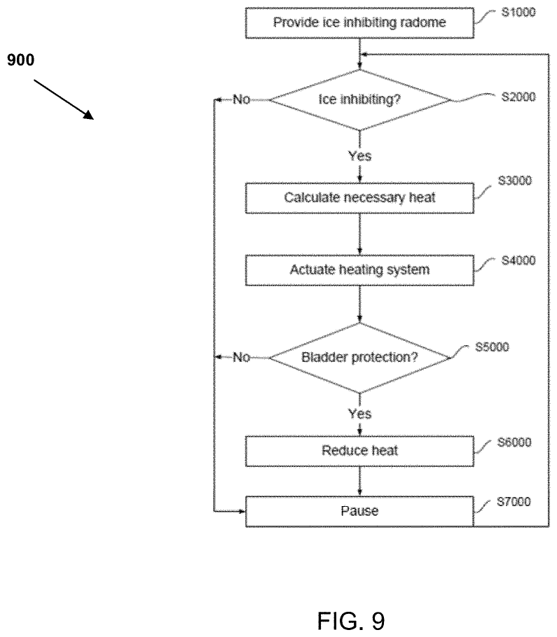

FIG. 9 is a block diagram of a method 900, which may be a computer-implemented method in whole or in part, according to one or more embodiments of the disclosed subject matter.

In block S1000, a radome system such as described herein can be provided.

In block S2000, it can be determined if ice inhibition is necessary or desired. Such determination can be performed using sensors and/or a controller/control unit, such as described above. Additionally or alternatively, a user may identify whether ice inhibition is necessary or desired. Further, the determination that ice inhibition is necessary or desired can be performed automatically through software instructions executed on the circuitry G-1000, for instance, and based on at least the meteorological conditions, for instance, electronically sensed meteorological conditions. As a non-limiting example, the software instructions can be written and the circuitry G-1000 can be configured to receive the meteorological sensing signals SW from the plurality of meteorological sensors F-1100, extract meteorological values from the meteorological sensing signals SW, compare the extracted meteorological values to meteorological thresholds, and determine if ice inhibiting is necessary or desirable.

For example, the software instructions can be written and the circuitry G-1000 can be configured to receive the external temperature signals SWT from the temperature sensor F-1110, extract temperature values from the external temperature signals SWT, and compare the extracted temperature values to predetermined temperature thresholds to commensurate with ice and/or snow formation, e.g., freezing point temperatures. If the extracted temperature values are below the predetermined temperature thresholds To it can be determined that ice inhibiting is necessary or desirable.

In another example, the software instructions can be written and the circuitry G-1000 can be configured to receive the external humidity signals SWH from the humidity sensor F 1120, extract humidity values from the external humidity signals SWH, and compare the extracted humidity values to predetermined humidity thresholds Ho commensurate with ice and/or snow formation. If the extracted humidity values are above the predetermined humidity thresholds Ho it is determined that ice inhibiting is necessary or desirable.

In yet another example, the software instructions and the circuitry G-1000 can be configured to receive the external wind signals SWW from the anemometer sensor F-1130, extract wind values from the external wind signals SWW, and compare the extracted wind values to predetermined wind thresholds Wo commensurate with ice and/or snow deposition on the outer membrane. If the extracted wind values are above the predetermined wind thresholds Wo it is determined that ice inhibiting is necessary or desirable.

If it is determined that ice inhibiting is necessary or desirable, the process can proceed to block S3000. Otherwise, the process can proceed to block 57000.

In the block 57000, the process can be paused or stopped during a predetermined period Tb commensurate with weather condition changes. For example, Tb can be between 1 min and 1 week, and preferably between 3 hours and 24 hours.

In the block S3000, an amount of heat to prevent ice formation and/or accumulation on the outer membrane can be optionally calculated and provided to the air for supply to the radome bladder. The optional calculation of the amount of heat can be performed automatically through software instructions and executed on the circuitry G-1000 based on the meteorological values extracted in the block S2000. The amount of heat can corresponds to variations and/or differences between the meteorological values extracted in the block S2000 and the meteorological thresholds. For example, the amount of heat can correspond to temperature differences between the temperature thresholds To and the extracted temperature values.

In block S4000, an air supply system can be actuated to provide the heat according to the calculation in the block S3000 to the air for supply to the radome bladder. The actuation of the air supply system can be performed automatically through software instructions executed on the circuitry G-1000. The software instructions and the circuitry G-1000 can be configured to send heating actuation signals AH commensurate with the amount of heat to the heating actuators F-1300 of the heating system. In another example, the circuitry G-1000 can be configured to send flow actuation signals AHF commensurate with a heat flow producing the necessary heat to the flow regulator F-1320.

In block S5000, it can be determined if bladder protection is needed or desired. The determination that bladder protection is needed can be performed automatically through software instructions executed on the circuitry G-1000 and based on the bladder conditions, for instance. The software instructions can be written and the circuitry G-1000 can be configured to receive the bladder sensing signals SB from the plurality of bladder sensors F-1200, extract bladder values from the bladder sensing signals SB, compare the extracted bladder values to bladder thresholds, and determine if the bladder protection is necessary or desired.

For example, the circuitry G-1000 can be configured to receive the bladder temperature signals SBT from the bladder temperature sensor F-1210, extract bladder temperature values from the bladder temperature signals SBT, and compare the extracted bladder temperature values to predetermined bladder temperature thresholds BTo commensurate with determinations associated with the outer membrane and/or the inner membrane. If the extracted bladder temperature values are below the predetermined bladder temperature thresholds To it can be determined that the bladder protection is necessary or desired.

In another example, the circuitry G-1000 can be configured to receive the bladder stretch signals SBS from the bladder stretch sensor F-1220, extract bladder stretch values from the bladder stretch signals SBS, and compare the extracted bladder stretch values to predetermined bladder stretch thresholds BSo commensurate with deterioration of the outer membrane and/or the inner membrane. If the extracted bladder stretch values are above the predetermined bladder stretch thresholds BSo, for instance, which may be indicative of added weight from an external source to the outer surface of the radome bladder, it can be determined that the bladder protection is necessary or desired.

If it is determined that the bladder protection is necessary or desired, the process can proceed to block 56000. Otherwise, the process can proceed to block 57000.

In the block 56000, the air supply system can be actuated to expand the radome bladder. Optionally, activation can also include deactivation, meaning the radome bladder can be returned to an unexpanded state. The actuation of the air supply system can be performed automatically through software instructions executed on the circuitry G-1000. Optionally, in a case where heating is implemented, deactivation can involve the circuitry G-1000 sending heating actuation signals AH commensurate with a decrease of the amount of heat generated to the heating actuators F-1300. For example, the circuitry G-1000 can be configured to send heating energy signals AHE commensurate with a predetermined temperature reduction to the heating regulator F-1310. In another example, the circuitry G-1000 can be configured to send flow actuation signals AHF commensurate with a predetermined flow reduction to the flow regulator F-1320.

Embodiments of the disclosed subject matter may also be as set forth according to the parentheticals in the following paragraphs.

(1) An ice inhibiting radome system, comprising: an air supply configured to provide an oscillating flow of air at a predetermined flow rate over a plurality of pressurization/depressurization oscillation cycles; a radome bladder fluidly connected to the air supply to receive the oscillating flow of air, the radome bladder having: an inner stretched membrane, an outer stretched membrane, the outer stretched membrane having an inner surface and an outer surface, the outer surface being smooth, at least one air inlet port configured to receive the oscillating flow of air and provide the oscillating flow of air to a variable volume chamber defined between the inner stretched membrane and the outer stretched membrane, and at least one air outlet port configured to output air from the variable volume chamber defined between the inner stretched membrane and the outer stretched membrane, wherein a peripheral portion of the inner stretched membrane is fixed to a peripheral portion of the outer stretched membrane to create an air-tight seal; a mechanical tensioning assembly coupled to the radome bladder and configured to provide adjustable tensioning of the inner stretched membrane and the outer stretched membrane; and control circuitry configured to control the air supply to controllably provide the oscillating flow of air at the predetermined flow rate to the variable volume chamber defined between the inner stretched membrane and the outer stretched membrane, via the at least one air input port, such that, for each said pressurization/depressurization oscillation cycle, the air causes adjacent portions of the inner stretched membrane and the outer stretched membrane to move apart and thereby increase the variable volume chamber during a pressurization phase of the oscillation cycle, and controllably output the air, via the at least one air output port, from the variable volume chamber, to cause the adjacent portions of the inner stretched membrane and the outer stretched membrane to move toward each other and thereby decrease the variable volume chamber during a depressurization phase of the oscillation cycle, wherein, during each said pressurization/depressurization oscillation cycle each of the inner stretched membrane and the outer stretched membrane goes from a pre-stressed state to an increased-stress state and back to the pre-stressed state.

(2) The ice inhibiting radome system of (1), wherein the air provided by the air supply is unheated air.

(3) The ice inhibiting radome system of (1) or (2), wherein the air is provided at the predetermined flow rate only during the pressurization phase of the oscillation cycle.

(4) The ice inhibiting radome system of any one of (1) to (3), wherein the predetermined flow rate is between about 1 m³/s to about 20 m³/s.

(5) The ice inhibiting radome system of any one of (1) to (4), wherein the air supply is one of an industrial blower and an air compressor.

(6) The ice inhibiting radome system of any one of (1) to (5), wherein the outer surface of the outer stretched membrane remains at ambient temperature during the plurality of pressurization/depressurization oscillation cycles.

(7) The ice inhibiting radome system of any one of (1) to (6), wherein the outer surface of the outer stretched membrane is coated with polytetrafluoroethylene (PTFE).

(8) The ice inhibiting radome system of any one of (1) to (7), wherein each said pressurization/depressurization oscillation cycle lasts from about three seconds to about three minutes.

(9) The ice inhibiting radome system of any one of (1) to (8), wherein the air supply includes a heater configured to heat air so the air supply provides heated air as the air provided to the radome bladder.

(10) The ice inhibiting radome system of any one of (1) to (9), further comprising one or more icing sensors configured to sense ice buildup and/or impending ice buildup on the outer surface of the outer stretched membrane, wherein the controller is configured to start a first one of said pressurization/depressurization oscillation cycles responsive to a signal from the one or more icing sensors that ice has built up or will imminently build up on the outer surface of the outer stretched membrane.

(11) A method of removing or preventing ice and/or snow accumulation on a radome using a flexible radome bladder, the method comprising: providing the radome, the radome including: the flexible radome bladder, the flexible radome bladder being fluidly connected to an air supply to receive forced air from the air supply and having: an inner membrane provided in parallel with an outer membrane, the outer membrane having an inner surface that touches an inner surface of the inner membrane, and an outer surface that faces away from the inner membrane, at least one air inlet port configured to receive the forced air from the air supply and provide the forced air between the inner membrane and the outer membrane, and at least one air outlet port configured to output air from between the inner membrane and the outer membrane; determining an ice and/or snow accumulation condition relative to the outer surface of the outer membrane; and controlling, using a processor, a center portion of the outer membrane to move away from a center portion of the inner membrane, responsive to said determining the ice and/or snow accumulation condition, by forcing the air from the air supply between the inner membrane and the outer membrane, wherein said controlling causes the outer membrane to move from a first pre-stressed state to a first increased-stress state.

(12) The method of (11), further comprising controlling, using the processor, the center portion of the outer membrane to move toward the center portion of the inner membrane, immediately after said controlling the center portion of the outer membrane to move away from the center portion of the inner membrane.

(13) The method of (11) or (12), wherein said controlling includes controlling the center portion of the inner membrane to move away from the center portion of the outer membrane, responsive to said determining the ice and/or snow accumulation condition, by forcing the air from the air supply between the inner membrane and the outer membrane, wherein said controlling causes the inner membrane to move from a second pre-stressed state to a second increased-stress state.

(14) The method of any one of (11) to (13), further comprising heating the air prior to forcing the air from the air supply between the inner membrane and the outer membrane, the air forced between the inner membrane and the outer membrane being heated air.

(15) The method of any one of (11) to (14), further comprising repeatedly controlling, using the processor, the center portion of the outer membrane to move away from the center portion of the inner membrane by forcing the air from the air supply between the inner membrane and the outer membrane.

(16) The method of any one of (11) to (15), wherein the forced air provided between the inner membrane and the outer membrane pressurizes a chamber of the flexible radome bladder formed between the inner membrane and the outer membrane.

(17) A flexible radome bladder system comprising: at least one inner tensioned membrane having an inner surface and an outer surface opposite the inner surface; at least one outer tensioned membrane provided adjacent to the at least one inner tensioned membrane, the at least one outer tensioned membrane having an inner surface facing the at least one inner tensioned membrane and an outer surface facing away from the at least one inner tensioned membrane; at least one air inlet port configured to provide air between the at least one outer tensioned membrane and the at least one inner tensioned membrane; and at least one air outlet port configured to output the air provided between the at least one outer tensioned membrane and the at least one inner tensioned membrane, wherein the at least one inner tensioned membrane and the at least one outer tensioned membrane are affixed to each other to create an air-tight seal around the at least one inner tensioned membrane and the at least one outer tensioned membrane, and wherein the at least one inner tensioned membrane and the at least one outer tensioned membrane are configured such that respective inner portions are movable between a pre-tensioned state where no air is being provided between the at least one inner tensioned membrane and the at least one outer tensioned membrane and a predetermined increased-tension state when air is being or has been provided between the at least one inner tensioned membrane and the at least one outer tensioned membrane.

(18) The flexible radome bladder system of (17), wherein the inner tensioned membrane and the outer tensioned membrane form a flat planar radome.

(19) The flexible radome bladder system of (17) or (18), wherein the at least one air inlet port and the at least one air outlet port are the same.

(20) The flexible radome bladder system of any one of (17) to (19), further comprising a mechanical tensioning assembly coupled to one or more of the at least one inner tensioned membrane and the at least one outer tensioned membrane configured to provide tensioning of the inner tensioned membrane and the outer tensioned membrane at the pre-tensioned state.

Having now described embodiments of the disclosed subject matter, it should be apparent to those skilled in the art that the foregoing is merely illustrative and not limiting, having been presented by way of example only. Thus, although particular configurations have been discussed and illustrated herein, other configurations can be and are also employed. Further, numerous modifications and other embodiments (e.g., combinations, rearrangements, etc.) are enabled by the present disclosure and are contemplated as falling within the scope of the disclosed subject matter and any equivalents thereto. Features of the disclosed embodiments can be combined, rearranged, omitted, etc., within the scope of described subject matter to produce additional embodiments. Furthermore, certain features may sometimes be used to advantage without a corresponding use of other features. Accordingly, Applicant intends to embrace all such alternatives, modifications, equivalents, and variations that are within the spirit and scope of the present disclosure. Further, it is therefore to be understood that within the scope of the appended claims, the disclosure may be practiced otherwise than as specifically described herein.

What is claimed is:

1. An ice inhibiting radome system, comprising:
an air supply configured to provide an oscillating flow of air at a predetermined flow rate over a plurality of pressurization/depressurization oscillation cycles;
a radome bladder fluidly connected to the air supply to receive the oscillating flow of air, the radome bladder having:
an inner stretched membrane,
an outer stretched membrane, the outer stretched membrane having an inner surface and an outer surface, the outer surface being smooth,
at least one air inlet port configured to receive the oscillating flow of air and provide the oscillating flow of air to a variable volume chamber defined between the inner stretched membrane and the outer stretched membrane, and
at least one air outlet port configured to output air from the variable volume chamber defined between the inner stretched membrane and the outer stretched membrane,
wherein a peripheral portion of the inner stretched membrane is fixed to a peripheral portion of the outer stretched membrane to create an air-tight seal;
a mechanical tensioning assembly coupled to the radome bladder and configured to provide adjustable tensioning of the inner stretched membrane and the outer stretched membrane; and
control circuitry configured to
control the air supply to controllably provide the oscillating flow of air at the predetermined flow rate to the variable volume chamber defined between the inner stretched membrane and the outer stretched membrane, via the at least one air input port, such that, for each said pressurization/depressurization oscillation cycle, the air causes adjacent portions of the inner stretched membrane and the outer stretched membrane to move apart and thereby increase the variable volume chamber during a pressurization phase of the oscillation cycle, and
controllably output the air, via the at least one air output port, from the variable volume chamber, to cause the adjacent portions of the inner stretched membrane and the outer stretched membrane to move toward each other and thereby decrease the variable volume chamber during a depressurization phase of the oscillation cycle,
wherein, during each said pressurization/depressurization oscillation cycle each of the inner stretched membrane and the outer stretched membrane goes from a pre-stressed state to an increased-stress state and back to the pre-stressed state.

2. The ice inhibiting radome system of claim 1, wherein the air provided by the air supply is unheated air.

3. The ice inhibiting radome system of claim 1, wherein the air is provided at the predetermined flow rate only during the pressurization phase of the oscillation cycle.

4. The ice inhibiting radome system of claim 1, wherein the predetermined flow rate is between about 1 m³/s to about 20 m³/s.

5. The ice inhibiting radome system of claim 1, wherein the air supply is one of an industrial blower and an air compressor.

6. The ice inhibiting radome system of claim 1, wherein the outer surface of the outer stretched membrane remains at ambient temperature during the plurality of pressurization/depressurization oscillation cycles.

7. The ice inhibiting radome system of claim 1, wherein the outer surface of the outer stretched membrane is coated with polytetrafluoroethylene (PTFE).

8. The ice inhibiting radome system of claim 1, wherein each said pressurization/depressurization oscillation cycle lasts from about three seconds to about three minutes.

9. The ice inhibiting radome system of claim 1, wherein the air supply includes a heater configured to heat air so the air supply provides heated air as the air provided to the radome bladder.

10. The ice inhibiting radome system of claim 9, further comprising one or more icing sensors configured to sense ice buildup and/or impending ice buildup on the outer surface of the outer stretched membrane,
wherein the controller is configured to start a first one of said pressurization/depressurization oscillation cycles responsive to a signal from the one or more icing sensors that ice has built up or will imminently build up on the outer surface of the outer stretched membrane.

11. A method of removing or preventing ice and/or snow accumulation on a radome using a flexible radome bladder, the method comprising:
providing the radome, the radome including:
the flexible radome bladder, the flexible radome bladder being fluidly connected to an air supply to receive forced air from the air supply and having:
an inner membrane provided in parallel with an outer membrane, the outer membrane having an inner surface that touches an inner surface of the inner membrane, and an outer surface that faces away from the inner membrane,
at least one air inlet port configured to receive the forced air from the air supply and provide the forced air between the inner membrane and the outer membrane, and
at least one air outlet port configured to output air from between the inner membrane and the outer membrane;
determining an ice and/or snow accumulation condition relative to the outer surface of the outer membrane; and
controlling, using a processor, a center portion of the outer membrane to move away from a center portion of the inner membrane, responsive to said determining the ice and/or snow accumulation condition, by forcing the air from the air supply between the inner membrane and the outer membrane,
wherein said controlling causes the outer membrane to move from a first pre-stressed state to a first increased-stress state.

12. The method of claim 11, further comprising controlling, using the processor, the center portion of the outer membrane to move toward the center portion of the inner membrane, immediately after said controlling the center portion of the outer membrane to move away from the center portion of the inner membrane.

13. The method of claim 11,
wherein said controlling includes controlling the center portion of the inner membrane to move away from the center portion of the outer membrane, responsive to said determining the ice and/or snow accumulation condition, by forcing the air from the air supply between the inner membrane and the outer membrane, and
wherein said controlling causes the inner membrane to move from a second pre-stressed state to a second increased-stress state.

14. The method of claim 11, further comprising heating the air prior to forcing the air from the air supply between the inner membrane and the outer membrane, the air forced between the inner membrane and the outer membrane being heated air.

15. The method of claim 11, further comprising repeatedly controlling, using the processor, the center portion of the outer membrane to move away from the center portion of the inner membrane by forcing the air from the air supply between the inner membrane and the outer membrane.

16. The method of claim 15, wherein the forced air provided between the inner membrane and the outer membrane pressurizes a chamber of the flexible radome bladder formed between the inner membrane and the outer membrane.

17. A flexible radome bladder system comprising:
an inner tensioned membrane having an inner surface and an outer surface opposite the inner surface;
an outer tensioned membrane provided adjacent to the inner tensioned membrane, the outer tensioned membrane having an inner surface facing the inner tensioned membrane and an outer surface facing away from the inner tensioned membrane;
at least one air inlet port configured to provide air between the outer tensioned membrane and the inner tensioned membrane; and
at least one air outlet port configured to output the air provided between the outer tensioned membrane and the inner tensioned membrane,
wherein the inner tensioned membrane and the outer tensioned membrane are affixed to each other to create an air-tight seal around the inner tensioned membrane and the outer tensioned membrane, and
wherein the inner tensioned membrane and the outer tensioned membrane are configured such that respective inner portions are movable between a pre-tensioned state where no air is being provided between the inner tensioned membrane and the outer tensioned membrane and a predetermined increased-tension state when air is being or has been provided between the inner tensioned membrane and the outer tensioned membrane.

18. The flexible radome bladder system of claim 17, wherein the inner tensioned membrane and the outer tensioned membrane form a flat planar radome.

19. The flexible radome bladder system of claim 17, wherein the at least one air inlet port and the at least one air outlet port are the same.

20. The flexible radome bladder system of claim 17, further comprising a mechanical tensioning assembly coupled to the inner tensioned membrane and the outer tensioned membrane configured to provide tensioning of the inner tensioned membrane and the outer tensioned membrane at the pre-tensioned state.
